(19) United States
(12) Patent Application Publication
(10) Pub. No.: US 2010/0128559 A1
(43) Pub. Date: May 27, 2010

(54) Tabletop device for mixing and discharging multi-component compounds

(75) Inventor: Wilhelm A. Keller, Merlischachen (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Mixpac AG, Haag (CH)

(21) Appl. No.: 12/596,974

(22) PCT Filed: Mar. 25, 2008
(86) PCT No.: PCT/EP08/53457

§ 371 Date: Oct. 21, 2009

(30) Foreign Application Priority Data
May 1, 2007 (CH) 00714/07

(51) Int. Cl. B01F 15/02

(52) U.S. Cl. 366/196

(57) ABSTRACT

The invention relates to a tabletop device for mixing and discharging multi-component compounds, particularly a dental impression compound, having discharging plungers (8a, 8b), a motorized drive (24) for the discharging plunger (8a, 8b), a switchable coupling (30) for the coupling or decoupling of the discharging plunger (8a, 8b) to or from the motorized drive (24), and at least one handle (3a, 3b) for the displacement of the discharging plunger (8a, 8b) to be carried out manually in the decoupled state thereof. In order to minimize the design effort of such a tabletop device, the invention provides that the switchable coupling (30) comprises a coil spring (34) for the releasable frictional connection of the drive side (31) to the output side (14) of the coupling (30).

The invention relates to a tabletop device for the mixing and dispensing of multicomponent compounds, in particular of dental impression compounds or dental mold compounds, in accordance with the preamble of claim 1.

Such a tabletop device is known from EP 492 413 A1, wherein the plungers serving for the pressing out of the containers with the individual components are movable selectively either by an electric motor or manually via a handwheel. The latter in particular serves for the positioning of the plungers into a desired location, for example after the insertion of an only partly filled container and before the actual pressing-out procedure. The advantage of the manual positioning procedure is in the time gain associated therewith in comparison with a slow plunger movement which is powered via the electric motor and which is designed for the pressing-out procedure. To change over the tabletop device from the motor-powered operating mode to the manual operating mode and vice versa, a magnetic coupling is provided which can be activated synchronously with the electric motor. The known tabletop device suffers from the disadvantage that the use of a magnetic coupling brings along a comparatively high construction effort and has relatively large room requirements in addition to the high costs associated with it.

A tabletop device is known from EP 1 531 001 A1 in which the electric motor acts via a lever onto a plurality of clamping elements which act on the plungers and move them via a disk cam. This construction makes high demands on precision on its manufacture, associated with high expense, due to the required interaction of a plurality of mechanical clamping elements in a very small space.

It is the underlying object of the invention to provide a tabletop device of the initially named kind which has a compact structure while avoiding the aforesaid disadvantages and taking account of the required dispensing accuracy as well as taking a small cost and a simple manufacturing capability into account.

This object is satisfied in accordance with the invention by a tabletop device defined by claim 1. The wrap spring represents a simple and effective coupling element to reduce the space requirements and to ensure a reliable function thereof by way of construction. To satisfy the special demands of coupling in and out with respect to an alternately manual and motor-powered operation of the tabletop device, it is proposed to use the wrap spring such as is defined by claim 2.

The invention will be explained in more detail in the following with reference to a preferred embodiment and to the drawings with reference to which further properties and advantages of the invention result. There are shown:

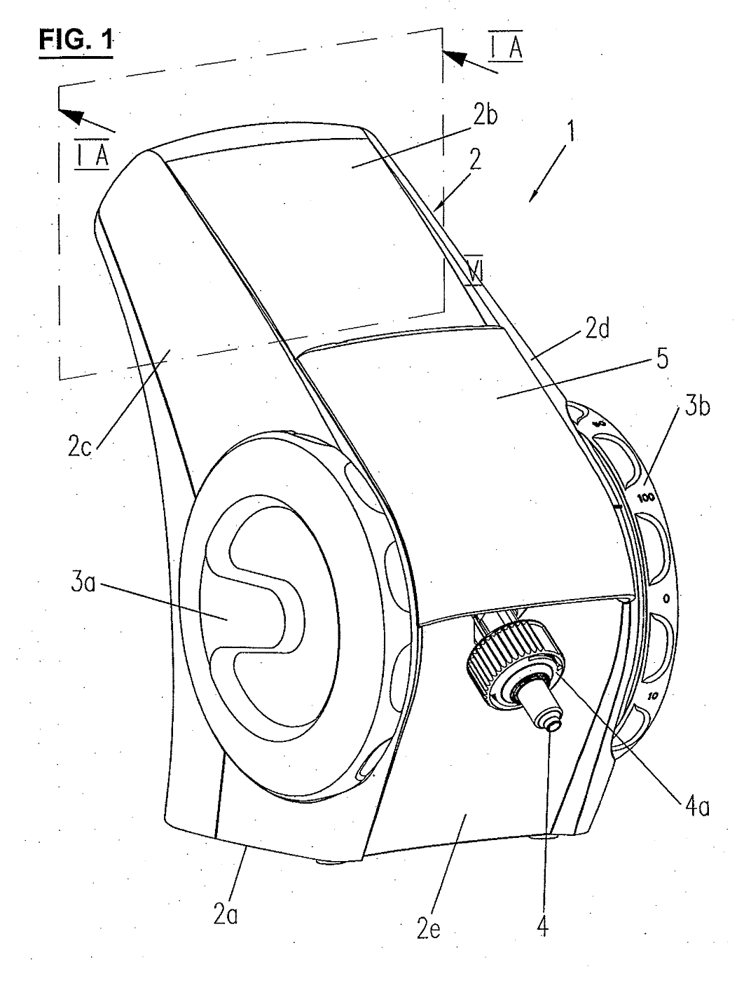

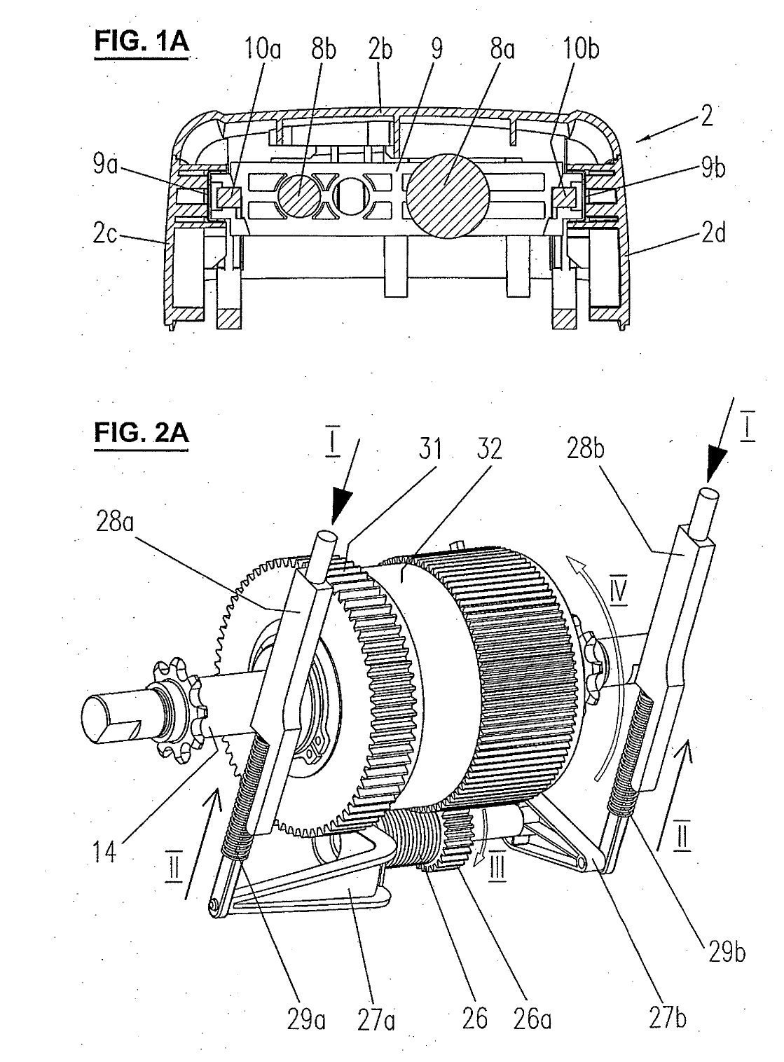

FIG. 1 a tabletop device in accordance with the invention for the dispensing of multicomponent compounds in a perspective outer view;

FIG. 1A a section of the tabletop device in accordance with the invention in accordance with the plane IA in FIG. 1;

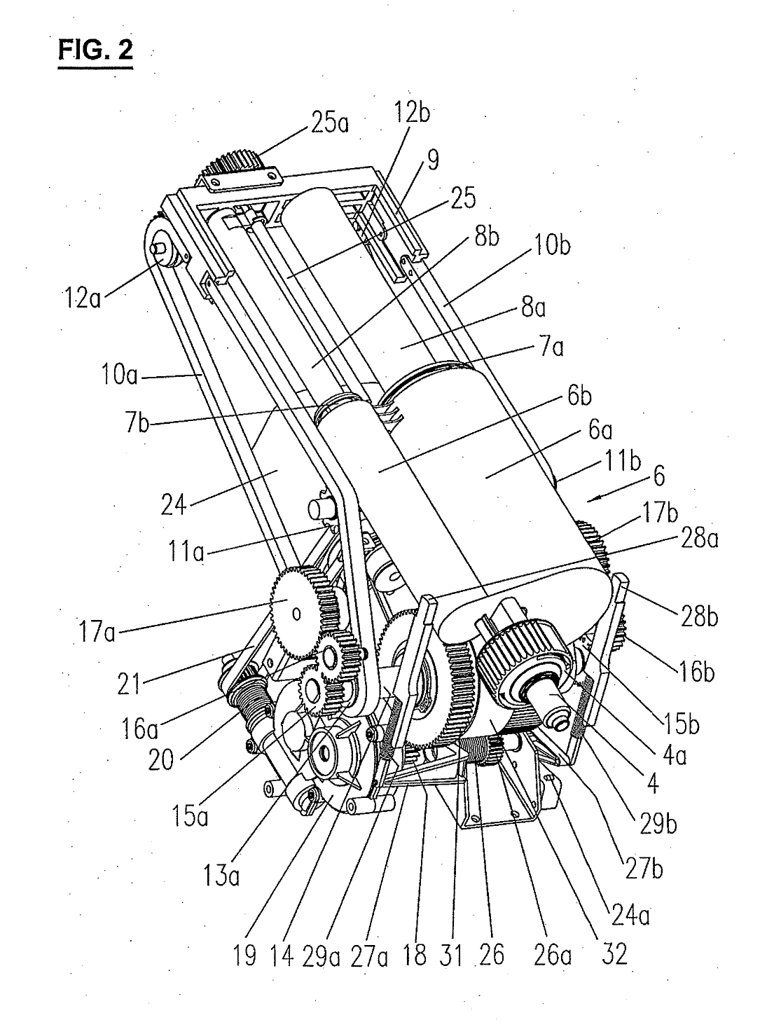

FIG. 2 the inner structure of the tabletop device shown in FIG. 1 in a corresponding perspective view;

FIG. 2A a detailed view of the switchable coupling of the inner structure of the tabletop device shown in FIG. 2, with the force flow acting on the pressing down of the housing cover being symbolized by arrows;

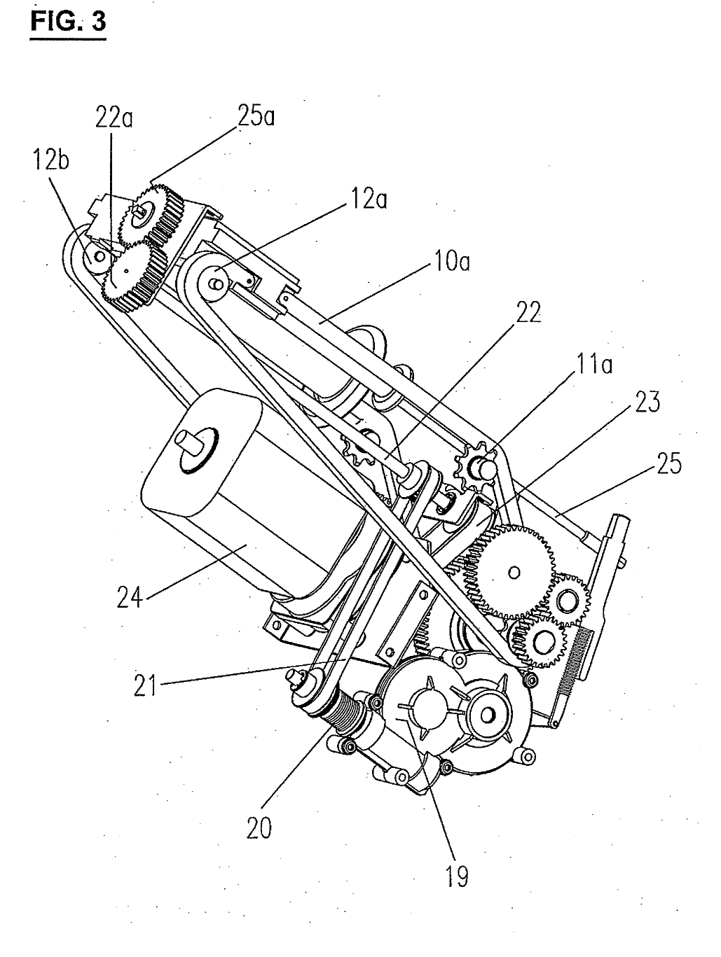

FIG. 3 the inner structure of the tabletop device in a perspective side view rotated through 90° with respect to FIG. 1 and FIG. 2, with the replaceable cartridge having been removed;

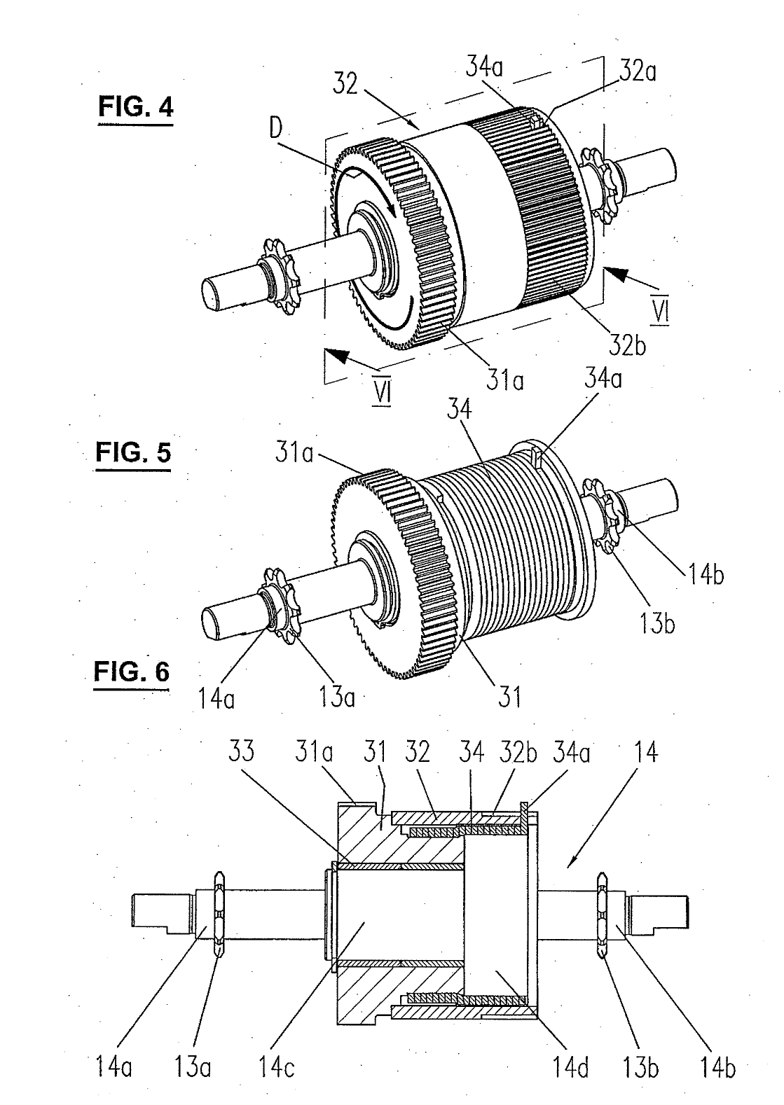

FIG. 4 a switchable wrap spring coupling in accordance with the invention of the drive of the dispensing plunger in the tabletop device shown in FIG. 1-FIG. 3 in a perspective view for the switching between a motor drive and a freewheel;

FIG. 6 the wrap spring coupling shown in FIG. 4, with the switching sleeve extending along the outer periphery having been removed; and

FIG. 6 the wrap spring coupling shown in FIG. 4 in a sectional view along the axis of rotation.

A tabletop device 1 shown in FIG. 1 includes a housing 2 whose lower side is bounded by a planar base 2a, whereas the upper boundary surface 2b is inclined toward the front side and extends beyond the base 2a in the direction of the rear side of the tabletop device 1.

A manual operation member in the form of at least one handwheel 3a or 3b respectively is provided at both side surfaces 2c and 2d respectively, said handwheel being operatively connected to the mechanism in the housing interior and serving for the manual forward feed or back stroke of the dispensing plungers. For the simplified operation of the handwheels 3a, 3b, they are made with gripping aids.

The front surface 2e of the housing 2 has an opening through which the end of the cartridge 6 projects at whose end the dynamic mixer 4 for the mixing of the components is fastened by means of a retainer nut 4a.

A substantially rectangular cover 5 which can be flipped open, on the one hand, and thus provides access to the cartridge space is formed in the front section of the upper boundary surface 2b. On the other hand, the cover 5 satisfies the function in the folded closed state of a push button which is operatively connected to the mechanism in the interior space of the housing, in particular to the control of the motor drive. It is prevented for safety reasons with this concept that the dispensing procedure can be carried out with an open cover. Independently of the type of drive used and of a coupling optionally connected thereto, the realization of the cover 5 as a push button which can be flipped open thus has the advantage that sources of damage and danger are reduced.

The mechanical structure in the interior of the housing 2 of the tabletop device 1 is shown in FIGS. 2 and 3. The manually replaceable cartridge 6 includes two substantially cylindrical storage containers 6a and 6b, with the storage container 6a having a larger diameter and thus a larger volume in comparison with the storage container 6b. A plunger plate 7a, 7a is arranged at the respective rear ends of the storage containers 6a, 6b. A respective cylindrical dispensing plunger 8a, 8b is arranged adjacent to the respective rear ends of the plunger plates 7a, 7b. The dispensing plungers 8a, 8b in turn have a rigid connection to a carriage 9 at their respective opposite ends with respect to the plunger plates 7a, 7b.

The carriage 9 is made in the shape of a half-frame and is movable in the axial direction of extent of the dispensing plungers 8a, 8b or of the storage containers 6a, 6b. As is shown in FIG. 1A, the carriage 9 is guideably journaled for this purpose within laterally arranged guide grooves 9a, 9b in the direction of displacement of the dispensing plungers 8a, 8b. The guide grooves 9a, 9b are made as sheet metal rails which have a U shape in their cross-sections and which are each fastened in projections of the left hand or right hand lateral housing inner walls 2c, 2d. A straight-line, simultaneous movement of the dispensing plungers 8a, 8b is ensured by the guidance of the carriage 9 in the guide grooves 9a, 9b at both sides and a canting of the dispensing plungers 8a, 8b and of the plunger plates 7a, 7b fastened thereto at the end sides is effectively avoided in the inner space of the cartridge during the dispensing procedure.

It is clear to the person of ordinary skill in the art that the named advantages of the carriage 9 also come into effect in a conventional apparatus for the mixing and dispensing of multicomponent compounds, independently of the manner and of the construction of the coupling used and independently of the use of a motor-powered drive or of only a manual drive for the movement of the slide 9.

Again with reference to the mechanical structure shown in FIGS. 2 and 3, for the movement of the carriage 9, it is pivotally connected beneath its left hand and right hand boundaries respectively to two oppositely disposed ends of a guide chain 10a and 10b respectively. The direction of traction of the guide chain 10a and 10b respectively is defined in the axial direction of extent of the dispensing plungers 8a, 8b or of the storage containers 6a, 6b by two deflection chain gears 11a, 12a and 11b, 12b respectively arranged at the left and the right respectively. The drive of the guide chain 10a and 10b respectively takes place by a drive chain gear 13a and 13b respectively which is arranged on the left hand side and right hand side respectively of a main shaft 14 extending in the transverse direction of the tabletop device 1.

On the one hand, a manual drive of the main shaft 14 and thus of the carriage 9 is provided. For this purpose, a respective external gear 15a and 15b is fastened to the left hand outer end and to the right hand outer end respectively and is operatively connected via a respective idler gear 16a and 16b and a respective handwheel gear 17a and 17b to the respective handwheels 3a and 3b arranged at the side of the housing 2.

In addition, a motor drive of the main shaft 14 is provided. A switch between the manual and the motor drive is realized by a wrap spring coupling 30 arranged centrally on the main shaft 14. The drive side 31 of the wrap spring coupling 30 is operatively connected to the output of the transmission 19 via a transmission gear 18 by its gear-type formation 31a.

A slip clutch or friction clutch 20 is provided at the transmission input and is connected via a toothed belt 21 to a transmission shaft 22 which is located beneath the position of the cartridge 6 or of the dispensing plungers 8a, 8b substantially in the direction of extent thereof. The transmission shaft 22 is connected directly to the drive motor 24 via a further toothed belt 23 arranged at the front end of said transmission shaft. The speed of the drive motor 24 of, for example, 2700 revolutions per minute is in this respect stepped down to approximately 400 revolutions per minute of the transmission shaft 22. The friction clutch 20 serves as a security against overload, in particular for the case that the dynamic mixer was not replaced after hardening of a multicomponent compound from a preceding mixing procedure.

In addition, a transmission of the torque of the transmission shaft 22 takes place to a mixer shaft 25 which is arranged above and parallel thereto and which opens into the dynamic mixer 4 to drive it. The coupling between the transmission shaft 22 and the mixer shaft 25 is realized by a respective shaft gear 22a and 25a arranged at its rear end which mutually engage into one another. A rotation of the mixer shaft 25 results from this with an equivalent speed of approximately 400 revolutions per minute.

Beside the drive side 31 of the wrap spring coupling 30, the latter has a switching element in the form of a switching sleeve 32 which has a toothed arranged 32b at the right hand end in which the gear 26a of a freewheel 26 dependent on the direction of rotation engages. The freewheel 26 dependent on the direction of rotation is fastened at the respective left hand and right hand sides to the lever 27a and 27b respectively which is respectively pivotally connected to an upwardly directed ram 28a and 28b respectively. The rams 28a and 28b respectively are upwardly loaded, while in contact with the cover 5 of the housing 2, by a respective spring 28a and 29b. A switch 24a is located beneath the right hand lever 27b in its direction of pivoting and the drive motor 24 is activated on its actuation.

The tabletop device 1 described above includes diverse individual elements with a wrap spring, in particular the friction clutch 20 for the limiting of the torque and the freewheel 26 dependent on the direction of rotation whose operations can be considered known. In contrast, the use of the wrap spring coupling 30 is based in accordance with the invention on an innovative principle and will be explained in more detail in the following with reference to FIGS. 4-6.

The output side of the wrap spring coupling 30 is formed by the main shaft 14 which is formed substantially cylindrically, whose diameter at the two marginal regions 14a, 14b is identical and whose central region has a section 14c with a diameter larger in comparison therewith and a section 14d with an even larger diameter along a step. A drive chain gear 13a and 13b respectively is arranged at the respective left hand and right hand marginal regions 14a and 14b and drives the carriage 9 via the chains 10a and 10b respectively.

The drive side of the wrap spring coupling 30 in the form of a drive hub 31 is rotatably journaled by a slide bearing 33 arranged therebetween on the section 14c of the central region of the main shaft 14. The drive hub 31 substantially has the shape of a hollow cylinder with a constant inner diameter and different sections with outer diameters respectively decreasing in steps from left to right. The toothed arrangement 31 is arranged at the left hand outer section with the largest outer diameter and engages into the drive gear 18 to take up the torque of the motor drive. The right hand outer section has the smallest outer diameter which substantially coincides with that of the adjacent central section 14d of the main shaft 14.

A wrap spring 34 is pushed onto these mutually adjacent outer surfaces with a substantially constant diameter. The inner diameter of the wrap spring 34 in the relaxed state before the pushing on is in this respect smaller than that which is produced after the pushing on and on the wrapping around of the mutually adjacent outer surfaces. A force-transmitting connection or friction connection is formed by the spring tension between the wrap spring 34 and the two outer surfaces and accordingly a rigid connection between the drive hub 31 and the main shaft 14.

A switching sleeve 32 is rotatably attached to the sections covered by the wrap spring 34. The switching sleeve 32 has the form of a hollow cylinder whose right hand outer region has a peripheral toothed arrangement 32b which in turn cooperates with the freewheel gear 26a of the freewheel 26. Furthermore, a drive slit 32a is provided at the right hand margin in which an end hook 34a attached to the right hand end of the wrap spring engages.

The end hook 34a is moved along contrary to the sense of the winding direction of the wrap spring 34 by rotation of the switching sleeve 32 in the direction of rotation D of the transmission drive which is symbolized by an arrow in FIG. 4. With a preferred angle of rotation of approximately 3-15°, the friction connection of the wrap spring 34 releases from the central section 14a of the main shaft 14. A freewheeling of the main shaft 14 with respect to the transmission drive is thereby ensured and it enables a manual drive via the handwheel gears 17a, 17b of the handwheels 3a, 3b.

A possible procedure on the operation of the tabletop device 1 in accordance with the invention will be explained in detail in the following:

If the carriage 9 is located at its rearmost position, a cartridge 6 can be inserted into the tabletop device after opening the cover 5. In this respect, the wrap spring coupling is located at its position rotated by approximately 3°-15° in the direction of rotation D so that the main shaft 14 is decoupled from the drive shaft 31. By actuating the handwheel 3a, 3b, the cartridge can be moved quickly in the forward direction (and back) until the plunger plates 7a, 7b of the dispensing plungers 8a, 8b contact the dispensing piston of the cartridge 6.

After the cover 5 has been closed, its end at the dispensing side can be used as a push button. The force flow acting on the pressing of the cover is shown by the arrows in FIG. 2A. By actuation thereof, the rams 28a, 28b are pressed downward (arrow I), against the action of force by the springs 29a, 29b (arrow II). This in turns results in a pivot movement of the levers 27a, 27b toward the bottom, with in particular the switch 24a for the activation of the drive motor 24 being actuated by the right hand lever 27b. At the same time, the freewheel gear 26a of the freewheel 26 carries out a corresponding rotational movement (arrow III). The latter simultaneously produces a movement of the switching sleeve 32 (arrow IV) coupled thereto by approximately 3°-15° opposite to the direction or rotation D so that the wrap spring 34 is guided back into its tightly wound original position and enters into a friction connection with the main shaft 14. It is thus coupled into the drive side 31.

The transmission spindle 22 is driven via the toothed belt 23 by the drive motor 24 at a speed of e.g. approximately 400 revolutions per minute. It, on the one hand, drives the mixer spindle 25 of the mixer 4 via the gears 22a, 25a.

The drive gear 18 whose torque is transmitted via the wrap spring coupling 30 to the main shaft 14 is located at the drive output. The torque of the main shaft 14 is transmitted by the guide chains 10a, 10b via a linear traction movement into the carriage 9 so that the dispensing plungers 8a, 8b are loaded to bring the individual components into the dynamic mixer 4 which are mixed there and subsequently dispensed.

After the dispensing of the desired quantity of the multicomponent compound, the cover is released, whereby the rams 28a, 28b and the levers 27a, 27b are guided back upwardly into their starting position via the springs 29a, 29b. The switching sleeve 32 on the wrap spring coupling 30 is thereby guided back into its position rotated by 3°-15° in the direction of rotation D and the transmission drive is decoupled from the main shaft 14. At the same time, a deactivation of the drive motor 24 takes place by unloading the switch 24a via the lever 27b.

As a result of the fast decoupling of the drive 24, an immediate unloading of the carriage 9 or of the dispensing plungers 8a, 8b takes place which enables the immediate relaxation of the cartridge 6 via the cartridge pistons and thus largely prevents the continued flowing of the mixed components from the dynamic mixer 4.

After the replacement of the mixer 4, the device is ready for the next dispensing.

Since an automatic decoupling of the drive 24 takes place after every dispensing procedure, a manual moving back of the carriage 9 into the starting position is possible at any time by means of the handwheels 3a, 3b. This allows the removal of the partly or fully emptied cartridge 6 after the opening of the cover 5.

1. A tabletop device for the mixing and dispensing of multicomponent compounds, in particular of dental impression compounds or dental mold compounds, having dispensing plungers (8a, 8b), a motor drive (24) for the dispensing plungers (8a, 8b), a switchable coupling (30) for the coupling and decoupling of the dispensing plungers (8a, 8b) into or from the motor drive (24) and at least one manual operation member (3a, 3b) for the manually performable displacement of the dispensing plungers (8a, 8b) in the decoupled state thereof, characterized in that the switchable coupling (30) has a wrap spring (34) for the releasable friction connection of the drive side (31) to the output side (14) of the coupling.

2. A tabletop device in accordance with claim 1, characterized in that the friction connection of the wrap spring (34) is releasable on the output side for the decoupling of the dispensing plungers (8a, 8b) from the motor drive (24).

3. A tabletop device in accordance with claim 1, characterized by a switching element (32) peripherally rotatably journaled about the wrap spring (34) for the coupling or decoupling of the motor drive.

4. A tabletop device in accordance with claim 2, characterized by a fastening (32a) of the switching element (32) to the output-side end (34a) of the wrap spring (34).

5. A tabletop device in accordance with claim 3, characterized by an angle of rotation of the switching element (32) which can be fixed in a range between 3° and 15° for the coupling or decoupling of the dispensing plungers (8a, 8b) in dependence on the direction of rotation.

6. A tabletop device in accordance with claim 1, characterized by a mechanical coupling (17a, 16a, 15a, 17b, 16b, 15b) of the output side (14) with the manual operation member (3a, 3b).

7. A tabletop device in accordance with claim 1, characterized by a switch (24a) for the simultaneous activation of the motor drive (24) on the coupling of the dispensing plunger (8a, 8b).

8. A tabletop device in accordance with claim 7, characterized in that the switchable coupling (30) is switchable via at least one manually actuable ram (28a, 28b), with the ram (28a, 28b) being operatively connected to the wrap spring (34) of the switchable coupling (30).

9. A tabletop device in accordance with claim 2, characterized by a spring (29a, 29b) for the application of force to the ram (28a, 28b) such that the friction connection of the wrap spring (34) on the output side (14) is released without additional manual actuation of the ram (28a, 28b).

10. A tabletop device in accordance with claim 8, characterized by a foldable cover (5) for the opening of a space for the reception of cartridges (6) for the multicomponent compound, said cover being additionally made as a push button for the actuation of the ram (28a, 28b).

11. A tabletop device in accordance with claim 8, characterized in that at least one freewheel (26) depending on the direction of rotation is connected via a rotational lever (27a, 27b) between the ram (28a, 28b) and the wrap spring (34).

12. A tabletop device in accordance with claim 1, characterized in that the dispensing plungers (8a, 8b) are arranged in a carriage (9) which can be coupled or decoupled) to or from the motor drive (24) via the switchable coupling (30).

13. A tabletop device in accordance with claim 12, characterized in that at least one respective guide groove (9a, 9b) is provided along two oppositely arranged sides of the carriage (9) for the guidance of the carriage (9) in the direction of displacement of the dispensing plungers (8a, 8b).

14. A tabletop device in accordance with claim 1, characterized in that the motor drive (24) drives a dynamic mixer (4) via a central shaft (22).
